(19) United States
(12) Patent Application Publication
(10) Pub. No.: US 2008/0295032 A1
(43) Pub. Date: Nov. 27, 2008

(54) BUTTON PANEL CONFIGURATION AND DESIGN FOR A MOBILE COMPUTING DEVICE

(76) Inventors: Richard Gioscia, Santa Clara, CA (US); Yoshimichi Matsuoka, Cupertino, CA (US); Chrome Cebe, San Jose, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/754,257

(22) Filed: May 25, 2007

(51) Int. Cl. G06F 3/048

(52) U.S. Cl. 715/840

(57) ABSTRACT

A mobile computing device that includes an input area where mechanical interface features are provided in a layout that associates a specific kind of functionality with regions of the input area.

### TECHNICAL FIELD

The disclosed embodiments relate generally to the field of mobile computing devices. In particular, the disclosed embodiments pertain to a button panel configuration and design for a mobile computing device.

### BACKGROUND

Over the last several years, the growth of cell phones and messaging devices has increased the need for keypads and button/key sets that are small and tightly spaced. In particular, small form-factor keyboards, including QWERTY layouts, have become smaller and more tightly spaced. With decreasing overall size, there has been greater focus on efforts to provide functionality and input mechanisms more effectively on the housings.

In addition to a keyboard, mobile computing devices and other electronic devices typically incorporate numerous buttons to perform specific functions. These buttons may be dedicated to launching applications, short cuts, or special tasks such as answering or dropping phone calls. The configuration, orientation and positioning of such buttons is often a matter of concern, particularly when devices are smaller.

### BRIEF DESCRIPTION OF THE DRAWINGS

FIG. 1 illustrates a layout for a set of mechanical input features on a mobile computing device, according to an embodiment of the invention.

FIG. 2 illustrates one implementation of an input area for buttons of a mobile computing device, according to an embodiment of the invention.

FIG. 3 illustrates an input area for use on a mobile computing device, according to an embodiment of the invention.

FIG. 4A illustrates an input area for use on a mobile computing device, according to an embodiment of the invention.

FIG. 4B illustrates a close-up of a call action zone of an embodiment such as shown and described with FIG. 4A.

FIG. 4C illustrates a close-up of a navigation zone of an embodiment such as shown and described with FIG. 4A.

FIG. 5A illustrates an input area for use on a mobile computing device, according to another embodiment of the invention.

FIG. 5B illustrates a variation to an input area design such as shown and described in FIG. 5A, under an embodiment of the invention.

FIG. 6 is a simplified hardware diagram for use with one or more embodiments of the invention.

### DETAILED DESCRIPTION

Embodiments described herein provide for a mobile computing device that includes an input area where mechanical interface features are provided in a layout that associates a specific kind of functionality with regions of the input area. Mobile computing devices are increasingly using input areas in connection with displays and keypads to enable operation of applications, features, and other functionality of the mobile computing device. Through use of a layout such as described, one or more embodiments enable users to recognize through touch and tactile memory the functionality associated with a region or segment of the input area.

An embodiment includes a mobile computing device having a housing having a front panel, and a processor provided within the housing. Among other input features, the mobile computing device includes a multi-state button set that is operable to have multiple states of actuation. A first perimeter button is positioned adjacent or proximate to a first lateral edge of the front panel. A first intermediate button set positioned laterally between the edge and the navigation button set. The processor contained within the housing and configured to operate in a mode to (i) associate a set of multi-directional navigation functions with individual states of the multi-state button set, (ii) associate any one of two or more communication actions with the first perimeter button; and (iii) associate any one of a plurality of application or feature functions with each button of the first intermediate button set. The first perimeter button and each button of the first intermediate button set are positioned on the front panel to at least extend onto a section of the front panel that is defined by (i) a first boundary that extends laterally from a top edge of the multi-state button set to the first lateral edge, and (ii) a second boundary that extends laterally from a bottom edge of the multi-state button set to the first lateral edge.

According to another embodiment, a mobile computing device includes a housing having a front panel. The housing includes a processor. A multi-state button set, first and second perimeter button (or button set), and a first and second intermediate button set may define an input area on a face or surface of the housing. The multi-state button set is operable to have multiple states of actuation. Each of the first perimeter button and second perimeter button may be positioned adjacent or proximate to a first lateral edge of the front panel. The first and second intermediate button set is positioned laterally between the edge and the navigation button set. The processor is contained within the housing and configured to operate in a mode to (i) associate a set of multi-directional navigation functions with individual states of the multi-state button set, (ii) associate any one of two or more communication actions with the first perimeter button; and (iii) associate any one of a plurality of application or feature functions with each button of the first intermediate button set. The first perimeter button and each button of the first intermediate button set may be positioned on the front panel to at least overlap a section of the front panel that is defined by (i) a first boundary that extends laterally from a top edge of the multi-state button set to the first lateral edge, and (ii) a second boundary that extends laterally from a bottom edge of the multi-state button set to the first lateral edge.

Unless stated otherwise, the term “set” means “one or more”.

As used herein, the character “/” is an abbreviation for “and/or”.

As mobile communication devices and other small form-factor devices incorporate more functionality, devices increasingly accommodate a larger number of input mechanisms and features to enable the user to operate and interact with the device. For example, current mobile communication devices include an operating system, numerous applications, and abilities/functionality that include cellular telephony and messaging, image capture, and/or media playback.

Mobile communication devices often incorporate a combination of mechanical and software-based keys (sometimes referred to as soft or virtual keys), as well as other forms of input mechanisms (e.g. such as pads, joy-stick, dials, or touch-surfaces) to enable the user to operate the device. These keys enable the user to select functions such as application launch, software control and use, and navigation and/or selection of displayed objects.

The display screen itself can be used to select and operate many features, including icons and other features that can act as buttons or virtual buttons. Many devices include a navigation input mechanism that enable the user to navigate amongst and select displayed features. For example, navigation and selection operations may be used to select icons that launch applications.

As used herein, the term “logic” means a sequence of operations or functions performed by hardware, software, firmware or combinations thereof. Hardware logic is made up of circuits that perform an operation. Software logic is the sequence of instructions in a program.

Numerous types of computing devices may be used with embodiments described herein. One type of computing device that may be employed with one or more embodiments include mobile or portable computing devices, including wireless devices for use in messaging and telephony applications using cellular networks. Such devices are sometimes called “smart phones”, “hybrid devices” or “multi-function devices”. Mobile computing devices are generally small enough to fit in one hand, but provide cellular telephony features in combination with other applications. Examples of such other applications include contact applications for managing contact records, calendar applications for managing and scheduling events, task applications for keeping lists, and camera applications for capturing images. Additionally, many types of messaging transports may be provided on such mobile computing devices, including SMS, MMS, email and instant messaging.

Other examples of mobile computing devices contemplated for use with one or more embodiments described herein include portable media players, global positioning system devices, personal digital assistants, portable gaming machines, and/or devices that combine functionality of such devices. In addition, at least some embodiments described herein are applicable to desktop computers, laptops, and computer appliances (e.g. set-top boxes). A typical environment on which one or more embodiments may be implemented include a wireless or cellular device capable of both telephony and messaging or data transfer.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

### Overview

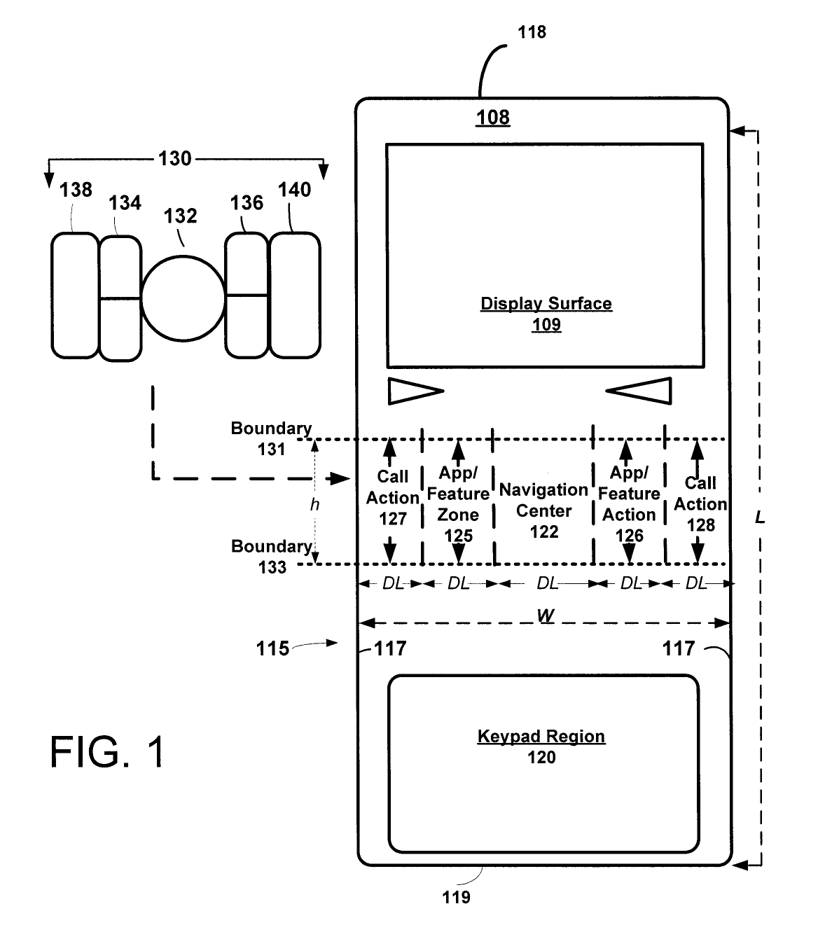

FIG. 1 illustrates a layout for a set of mechanical input features on a mobile computing device, according to an embodiment of the invention. In an embodiment, a device 100 includes a housing 115 that holds numerous components and interconnectivity elements, including processor(s), memory, and internal components of a display assembly. The housing 115 includes a front panel 108 having lateral edges 117, a top edge 118 and a bottom edge 119. A width W of the housing 115 may be defined by a distance between the lateral edges 117, 117. A length L of the housing 115 may be defined by a span that extends between the top edge 118 and the bottom edge 119. Each of the respective edges 117, 118, 119 may be shaped, edged or contoured to provide a transition from front panel 110 to another major surface or panel that is oriented in another direction.

According to one embodiment, the front panel 108 includes a display surface 109, and a keypad region 120 on which a keyboard (not shown) or other key layout is provided. Additionally, a plurality of mechanical input features 130 may be distributed on an input area 110 of the front panel 108. The input area 110 may correspond to a panel, strip or region of the front panel 108 that extends between lateral edges 117 of housing 115, and is positioned somewhere between the display surface 109 and a keypad region 120.

According to an embodiment, the mechanical input features 130 are provided in the form of a distribution or collection of buttons of various sizes or shapes. Alternative embodiments, such as described elsewhere in this application, may employ, for example, contact surfaces or other forms of mechanical input features. In one embodiment, the mechanical input features 130 include a center button set 132, a first set of intermediate buttons 134, a second set of intermediate buttons 136, a first set peripheral buttons 138, and a second set of peripheral buttons 140.

According to one or more embodiments, some or all of the input area 110 may be formed from an underlying surface that is structurally distinct from other surface areas of the front panel. For example, input area 11O may form a portion of a structurally raised, textured or otherwise distinct panel on which mechanical input features such as described herein are provided. Still further, another embodiment provides that the front panel 110 includes multiple surfaces, including a surface area that surrounds or merges with display surface 109, and a second and distinctive surface area on which the keypad 120 is provided. In such an implementation, for example, the input area 110 may be provided on one or both surfaces. In another implementation, the input area 110 may include a seamless and continuous segment that includes multiple contact-sensitive points that substitute for traditional buttons.

The distribution of at least some of the plurality of mechanical input features 130 in the input area 110 may be described in terms of zones. Each zone of the input area 110 refers to a region on the input area where a signal can be generated from manipulation of a mechanical input feature, where the signal generation is association with an action or operation that is of a type that is characteristic of the particular zone. Specific types of actions or operations include (i) navigation and selection operations, (ii) launching of a designated application, (iii) use of operation of a soft user-interface feature for enabling use or operation of other applications, and (iv) actions relating to wireless communications or applications for enabling wireless communications. Under one embodiment, each zone of the input area 110 can be characterized by a dimension D1 (extending in the direction of the width W of the front panel 108) that includes only buttons or mechanical input feature of that zone. One or more embodiments provide that within each zone, the only mechanical input features that are present are the features that perform functions of a class designated by the zone. Alternatively, one or more embodiments provide that within a given zone, the only mechanical input features that are operable in that zone are the features that perform functions of the class designated by the zone. In the latter case, a mechanical input feature may be extended between two zones, but may be primarily or solely operable in just one zone.

According to an embodiment such as shown by FIG. 1, a button in the input area 110 occupies only one zone. Each zone of the input area 110 may also be characterized by the height h of the input area 110 (extending in the direction of the length 1 of the front panel 108). As a result, a zone of the input area 110 may (i) have more than one button or mechanical input feature, but there are at least portions of each zone that do not share the button or mechanical input feature with an adjacent zone; (ii) a button or mechanical input feature of a particular zone need only overlap with the vertical dimension of the zone-thus, the zone does not need to completely contain its buttons or mechanical input features in the vertical dimension h.

Examples of buttons that may occupy zones (at least partially) on the front panel 110 include single-action buttons and toggle keys. Other examples of mechanical input feature include pads, joy sticks, jog dials or touch surfaces. Still further, one or more embodiments contemplate use of shaped and continuous surface that provides the exterior for multiple button areas. According to one implementation, such surfaces may be configured to shaped with respect to underlying switches and structure to simulate independent buttons.

With reference to FIG. 1, zones of the input area 110 include a navigation zone 122, a pair of application or feature zone 124, 125, and a pair of call action zones 127, 128. The navigation zone 122 includes a center 121 of the input area 110, as measured relative to the lateral edges 117. The call action zones 127, 128 form the perimeters of the input area 110. In one embodiment, the call action zones 127, 128 each extend towards center 121 from a respective one of the lateral edges 117, 117. Each of the application or feature zones 125, 126 are positioned between a corresponding one of the call action zones 127, 128 and the centrally positioned navigation zone 122.

In one embodiment, the center button set 132 may be disposed in the navigation zone 122 and coupled to the processor to provide navigation functionality. The first set of intermediate buttons 134 may be disposed on one of the application or feature zones 125, and the second set of intermediate buttons 136 may be disposed in the other of the application or feature zone 126. Each of the buttons in the first and second set of intermediate buttons 134, 136 may be coupled to the processor to provide functions that are one of (i) application launch or execution (if the particular button is an application button), or (ii) application control or use without execution or launch (if the particular button is a feature button). Likewise, the first set of perimeter buttons 138 may be disposed in the call action zone 127 and coupled to the processor to enable or provide a first call action when actuated. The second set of perimeter buttons 140 may be disposed in the call action zone 128 and coupled to the processor to enable or provide a second call action when actuated.

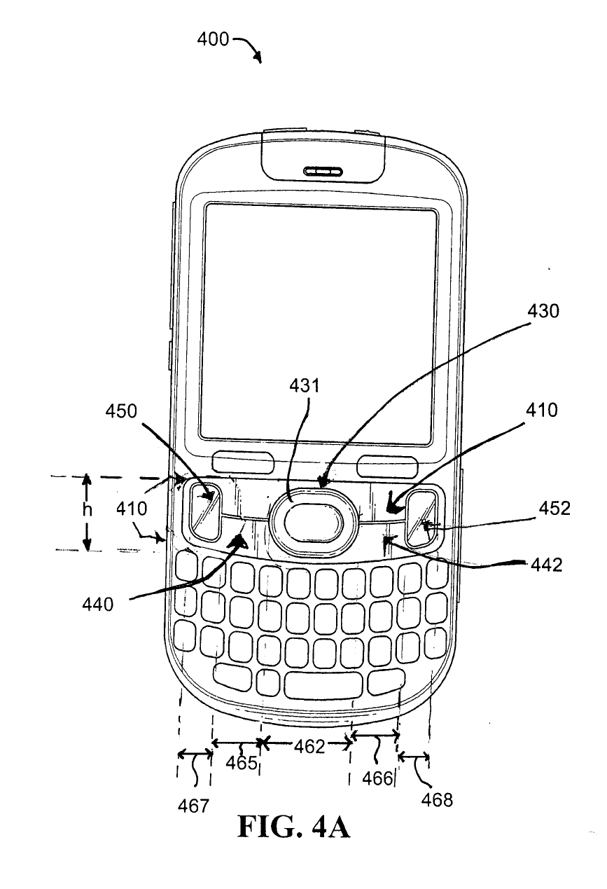

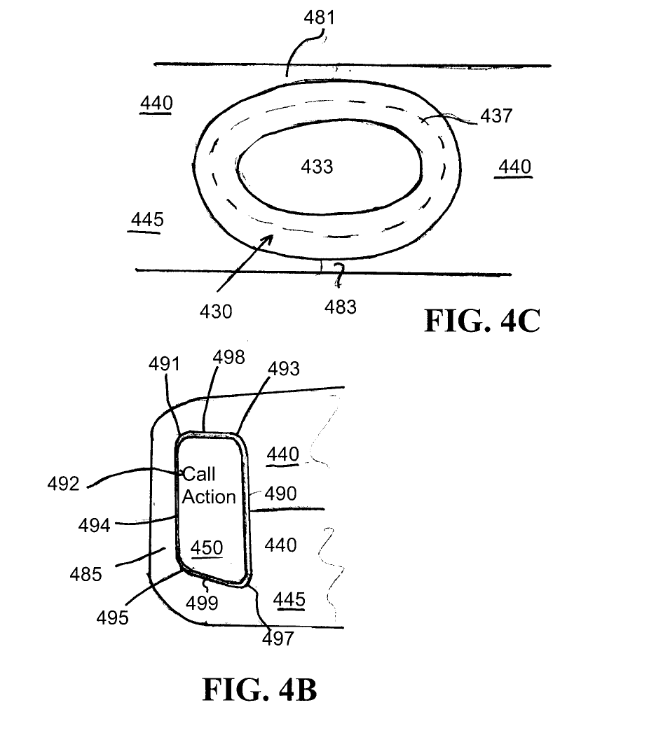

The input area 110 may further be defined by dimensions of a height h and a length l. In one embodiment, the length may correspond to the span of the button distributions in the width-wise direction of the front panel (i.e. along an axis extending between the lateral edges 117, 117). In one embodiment, the height of the input area is less than or equal to a vertical dimension (i.e. along an axis extending from the top edge 118 to the bottom edge 119) of the center button set 132 or button set (or other multi-state mechanical input feature (See FIG. 4C)).

The dimensions of the input area 110 are selected to set characteristics or requirements of how the components of the input area provide tactile landmarks to facilitate, for example, tactile memory on the front panel. Specifically, the characteristics or features of the input panel 110 (as defined by dimensions set forth above) provide the user with tactile landmarks that are informative of where the user's finger or thumb is when moving across the area 110. The environment is one where the user's thumb or finger moves quickly, so recognition of the thumb's position is immediate. Embodiments described herein recognize the benefits of tactile landmarks as means for providing reference positions that enable the user to locate and select use of mechanical input feature in the input area 110. One landmark may be provided by including the center button set 132 centrally in the navigation zone 122. The center button set 132 may itself form a tactile landmark by being differentiated from other buttons in the input area 110 through shape, dimensioning, and surface features. Additionally, the center button set 132 may be centrally positioned between the lateral edges 117 to further promote a tactile reference or center. The centrally positioned navigation mechanisms and lateral edges 117, 117 thus can combine to define the dimensions or span of the input area 110. Buttons or mechanical input feature that at least partially overlap with the input area may be identified through touch with assistance from the presence of the navigation mechanism and the lateral edges 117, 117.

The housing 115 of the device 100 may contain processing resources and numerous internal components of device 100. The functionality assigned to the mechanical input features provided in respective zones of the input area 110 may be implemented through processor configuration. The device 100 may be operable to enable the user to assign specific predetermined functions to individual buttons and mechanical input features, and the predetermined functions may differ from the functionality described with the zoning of the input area 110. Accordingly, one or more embodiments contemplate a mode of operation or default setting in which the processing resources of the device 100 provide the functionality that is indicated by the zoning of the input area in the manner described. Still further, one or more embodiments provide that device 100 includes logic, such as in the form of software executed by the processing resources of the device 100, that assigns functions or operations to individual buttons, so that actuation of the buttons causes the processor to perform the pre-assigned function or operation.

According to one or more embodiments, logic (as implemented through use of the processing resources) may provide that buttons/mechanical input features positioned to overlap specific zones perform a type of function. In one implementation, the communication actions performed by buttons or mechanical input features in the communication action zones 127, 128 include functionality for answering an incoming telephone call, terminating a phone call, displaying a phone log, and/or performing one or more operations using a telephony software application that executes on the device. The functionality performed by the buttons or mechanical input features of the application or feature zones 125, 126 when of the application type functionality, may correspond to the processor launching an application or presenting an already opened application to the user for use. The functionality performed by buttons or mechanical input features of the application or feature zones 125, 126, when of the feature type functionality, may be actuatable to trigger the processor to provide interfaces or functionality for operating the device or software applications that run on the device. The functionality performed by the button set of the navigation zone 122 may enable the user to navigate a selection state or pointer mechanism in any one of two or more directions, and to select a desired display object. In one embodiment, the navigation feature enables navigation in at least four directions (up, down, left, right) and selection.

As mentioned, the pre-assignment of functions to buttons may be enabled for a default state of device 100. For example, device 100 may be user-configured to accommodate alternative function assignments to buttons or actuation mechanisms/surfaces. Thus, a layout described with embodiments such as provided herein may be altered by user-configurations. Nevertheless, device 100 may be optimized, biased or otherwise configured to include a default state in which function assignments to individual buttons are distributed in a layout such as described with anyone or more embodiments herein.

With regard to embodiments described above, tactile landmarks may include the central region 140 and either lateral edge 117, 117. These landmarks enable the user to rapidly determine placement of his finger or thumb, for purpose of actuating the button for performing a desired function. The combination of the stated landmarks (and other distinctive features such as described below) enable the user to better identify buttons or mechanical input features of the input area 110 through the functionality attributed to the zoning of the input area 110.

According to an embodiment, distribution of mechanical input features in the input area 110 is symmetrical, in whole or in part, about the center 121. In one implementation, for example, buttons distributed between the center button set 132 and one of the lateral edges 117 mirror distribution of buttons distributed between the center button set 132 and the other of the lateral edges 117.

In addition to landmarks, input area 110 may be provided with various features and characteristics to promote tactile memory and feedback. The following provide various implementation examples of features and attributes to facilitate contact-sensitivity, tactile memory and feedback (and thumb-vision); (i) the center button set 132 may be enlarged and/or shaped differently from other buttons; (ii) the peripheral button set 127, 128 may be enlarged and/or shaped differently from other buttons; (iii) ridges or raised structures may separate the center button set 132 from the intermediate button sets 134, 136, and/or the intermediate button sets from the peripheral button sets 138, 140; and (iv) any of the buttons or buttons sets may be provided with grooves, recessions or impressions. Still further, one or more implementations provide for, for example, differing geometrical shapes, such as an oval navigation mechanism and square or rectangular application button sets. Still further, some of the buttons (e.g. the call action buttons) may be enlarged with respect to other buttons.

FIG. 2 illustrates one implementation of an input area for buttons of a mobile computing device, according to an embodiment of the invention. In FIG. 2, an input area 210 is provided for a front panel of a housing, such as shown and described with FIG. 1. The input area 210 includes a plurality of buttons or other input mechanisms with pre-determined function assignments. The buttons of the input area 210 overlay a pattern of switches 202. As an example, one or more embodiments provide for switches 202 that are in the form of a snap-dome electrical contact. Such switches may comprise and exterior dome that can collapse with inward pressure onto a contact or lead, resulting the generation of a signal that is communicated to a processor. Each switch 202 may underlie one of the buttons or input mechanisms of the input area 210, so that depression of that button triggers an electrical signal that is recognized by the processor of the device.

According to an embodiment, the input area 210 includes a navigation mechanism 230, a first set of application buttons 240, a second set of application buttons 242, a first communication action button 250, and a second communication action button 252. The navigation mechanism 230 corresponds to a multi-state button (e.g. 5-way button with four directional states and one center selection state) that is coupled to the processor (not shown) of the device to provide navigational functionality when individual states of the mechanism are selected. The navigation mechanism 230 occupies a central navigation zone 262 of the input area 110. The navigation mechanism 230 includes a height dimension h that defines the vertical dimension of the input area 210. A first projected boundary (which may be imaginary so as to reflect no physical line) may extend as a tangent from a top edge 221 of the navigation mechanism 230 to opposing lateral end points 217, 217 (which may represent the lateral edge of the front panel of the housing). A second projected boundary may extend as a tangent from a bottom edge 223 of the navigation mechanism to the opposing lateral end points 217, 217. The lateral dimension of the navigation zone 262 is set by the lateral span of the navigation mechanism 230.

Each of the first and second sets of the application buttons 240, 242 may correspond to buttons that are coupled to the processor to enable launch or execution of an assigned application when the corresponding button is actuated. The buttons of the first and second sets of the application buttons 240, 242 are disposed in application zones 264, 265 of the input area. The lateral dimension of the application zones 264, 265 correspond to the lateral span of the corresponding first or second set of application buttons 240, 242.

As an alternative or variation, one or more of the application buttons 240 may correspond to feature buttons, which provide user-interface functionality to enable control and use of applications (without directly resulting in application launching or execution). As an example, a feature button may launch a menu to other applications (e.g. “Start Menu”, display multiple applications from which one may be selected and launched, or perform some device control such as dimming the device's backlight. In such an implementation, the zones 264, 265 may be said to be feature zones, rather than application zones. Embodiments described herein contemplate the zones adjacent to the central navigation zone 262 as providing (i) exclusively application execution functionality (i.e. “application zones”), (ii) exclusively feature functionality (i.e. “feature zones”); or a (iii) a combination of application and feature functionality, in which some buttons are application buttons and other buttons or feature buttons. Each of the zones may include switches 202 for each button or input mechanism, or alternatively, for each actuated state of a button or mechanism. For example, the navigation zone 262 may include 5 switches for each actuated state of that mechanisms, and each application/feature zones 264, 265 may include one switch for each of the two buttons of that zone.

Each of the first and second communication action buttons 250, 252 are provided on peripheral ends of the lateral span of the input area 210. The first and second communication action buttons 250, 252 may correspond to buttons that are coupled to the processor to enable designated communication actions, such as “call answer” and “call hangup” in connection with a cellular telephony session. The communication action buttons 250, 252 are disposed in communication action zones 267, 268 of the input area 210. The lateral dimension of the communication action zones 267, 268 correspond to the lateral span of each buttons 250, 252.

While embodiments described herein provide that buttons and input mechanisms of the input area 210 are separated laterally into zones, buttons that are part of the zones may only need to vertically overlap with the input area 210 to be part of the zone. For example, in an embodiment shown by FIG. 2, the communication action buttons 250, 252 are enlarged as compared to the navigation mechanism 220, and each extends vertically out of the input area 210 and beyond both of the defined boundaries 211, 213. Individual application button of the first and second sets of application buttons 240, 242 are also shown to extend out of the input area 210 by extending past one of the two boundaries 211, 213.

With regard to an embodiment of FIG. 2, tactile memory and/or “thumb-vision” and operation of buttons or input mechanisms in the input area 210 may be facilitated with features or characteristics that include (i) laterally enlarging the navigation button 230 while vertically enlarging the call action buttons 250, 252, so as to provide tactile distinctiveness to the center and peripheral ends of the input area 210; (ii) shaping the buttons of the button panel differently (e.g. rectangular and elliptical); and/or (iii) eliminating housing separation between adjacent buttons in the lateral direction.

An embodiment of FIG. 2 illustrates the case where dimensions of buttons of the input area 210 delineate or form boundaries of the navigation zone, application/feature zones, and call action zones. Other embodiments, however, provide that the dimensions of some buttons do not delineate zones, but overlap adjacent zones. In such embodiments, the delineations of zones may be made by the underlying switch element, where the actuation signal from which the functionality that is characteristic of the zone is generated.

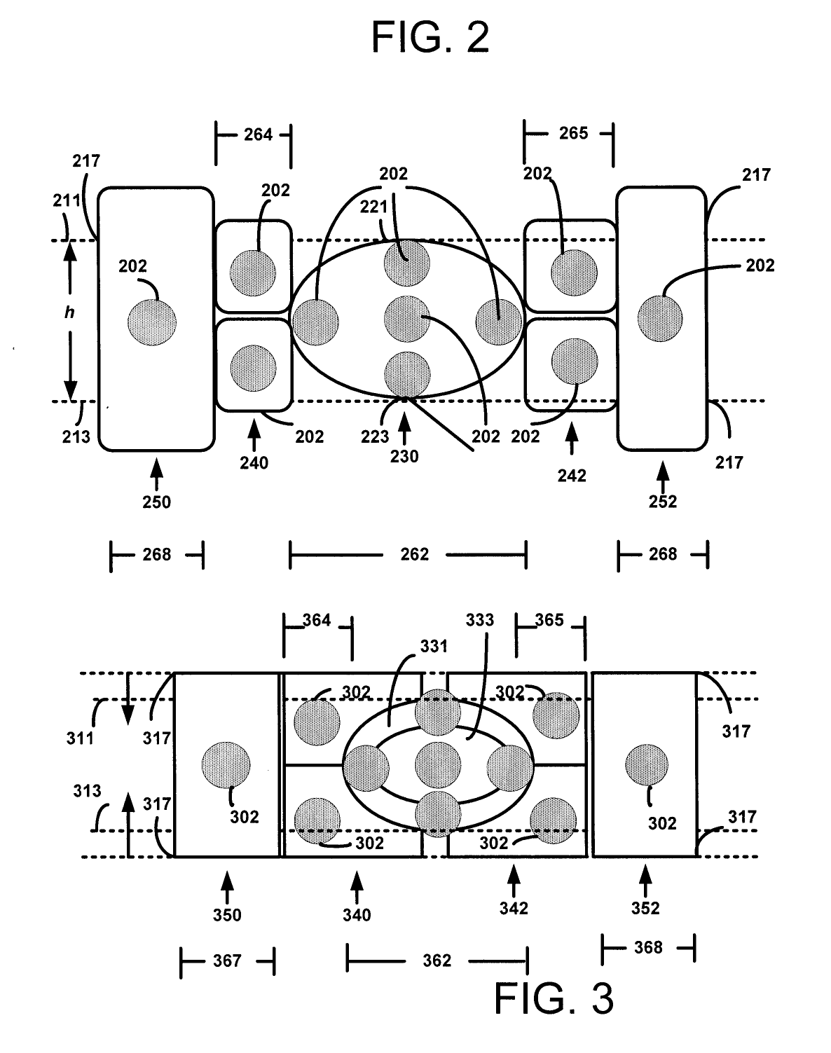

FIG. 3 illustrates an input area for use on a mobile computing device, according to an embodiment of the invention. In FIG. 3, an input area 310 is provided for a front panel of a housing, such as shown and described with FIG. 1. The input area 310 includes a plurality of buttons or other input mechanisms with pre-determined function assignments. The buttons of the input area 310 overlay a pattern of switches 302. Each switch 302 may underlie one of the buttons or input mechanisms of the input area 310, so that depression of that button triggers an electrical signal that is recognized by the processor of the device. The input area 3 10 may include a navigation mechanism 330, a first set of application buttons 340, a second set of application buttons 342, a first communication action button 350, and a second communication action button 352. As described, an embodiment of FIG. 3 illustrates that the lateral definition of zones may be determined by the location of electrical switches 302, rather than the shape or dimensions of buttons or input mechanisms.

According to an embodiment, navigation mechanism 330 corresponds to a combination of button mechanisms that combine to create a multi-state mechanism. In an implementation, the navigation mechanism 330 includes an outer annular ring 331 combined with a center select button 333. The outer annular ring 331 may be used to actuate a w-way arrange of electrical switches 302, so as to enable the generation of electrical signals that indicate some form of directional input. The center select button 333 may be selectable to actuate a fifth electrical switch 302 to trigger a selection signal. The combination of the annular ring 331 and the center select button 333 may provide, for example, 5-way button combination with four directional states (provided by operation of the outer annular ring 333) and one center selection state provided by operation of the center select button 333. With use of the electrical contacts 302, the navigation mechanism 330 is coupled to the processor (not shown) of the device to provide navigational functionality when individual states of the mechanism are selected. The navigation mechanism 330 occupies a central navigation zone 362 of the input area 310. The navigation mechanism 330 includes a height dimension h that defines the vertical dimension of the input area 310. A first projected boundary 311 (which is imaginary or reflects no physical line) may extend as a tangent from a top edge 311 of the navigation mechanism 330 to opposing lateral end points 317, 317 (which may represent the lateral edge of the front panel of the housing). A second projected boundary 313 may extend as a tangent from a bottom edge 333 of the navigation mechanism to the opposing lateral end points 317, 317. The lateral dimension of the navigation zone 362 is set by the lateral span of the navigation mechanism 330.

Each of the first and second sets of the application buttons 340, 342 may correspond to contact surfaces (e.g. buttons) that are coupled to the processor (not shown) to enable launch or execution of an assigned application when the corresponding button is actuated. Each contact surface in either of the application button sets 340, 342 may overlay one of the switches 302. Rather than form well defined buttons, the contact surfaces that form the application button sets 340, 342 may be shaped and contoured to extend and partially circumvent the navigation mechanism 330. As such, unlike an embodiment such as described with FIG. 2, the physical dimensions of the contact surfaces of the first and second sets of the application contact surfaces 340, 342 do not coincide with the vertical boundaries of the application zones because the application contact surfaces 340, 342 partially circumvent or surround the navigation mechanism. Specifically, an interior lateral dimension of each application contact surface overlaps a vertical boundary set by the perimeter of the navigation mechanism and/or its underlying electrical switches.

In an embodiment shown by FIG. 3, the application zones 364, 365 may be defined as the region in the input area 310 where the application buttons primarily reside and where the switches 302 for the application buttons underlie. The portion of the application buttons 340, 342 that extend into the navigation zone 362 are not operable in the navigation zone, but are operable over a region where underlying switches can be actuated. The application zones 364, 365 may be set as the area where (i) the majority of the application buttons 340, 342 reside, and/or (ii) where the application buttons 340, 342 can be pressed or moved inward (i.e. operated) to trigger underlying switches 302 for those buttons. Thus, the application zones 364, 365 may contain or correspond substantially to the area where the application buttons 340, 342 reside.

Each of the first and second communication action buttons 350, 352 are provided on peripheral ends of the lateral span of the input area 310. The first and second communication action buttons 350, 352 may correspond to buttons that are coupled to the processor to enable designated communication actions, such as “call answer” and “call hang-up” in connection with a cellular telephony session. The communication action buttons 350, 352 are disposed in communication action zones 367, 368 of the input area 310. The lateral dimension of the communication action zones 367, 368 correspond to the lateral span of each buttons 350, 352. In an embodiment such as shown by FIG. 3, the communication action zones 367, 368 do not laterally overlap with any other zone.

With regard to an embodiment of FIG. 3, tactile memory and/or “thumb-vision” and operation of buttons/input mechanisms in the input area 310 may be facilitated with features or characteristics that include (i) including surface features or divisions with the navigation mechanism 330 (e.g. annular ring 331); (ii) shaping the buttons of the button panel differently (e.g. irregular shape of the application buttons); and/or (iii) eliminating housing separation between adjacent buttons (e.g. application buttons) in the vertical direction. Of course, combinations of features employed with FIG. 3 and/or elsewhere may be used to further define and differentiate buttons for touch and use by the user.

While embodiments such as described with FIG. 2 and FIG. 3 teach the use of buttons or other push/switch mechanisms, any of the embodiments described herein may substitute contact-sensitive surfaces for use of buttons. Examples of contact-sensitive surfaces include resistive and capacitive pads that operate on touch.

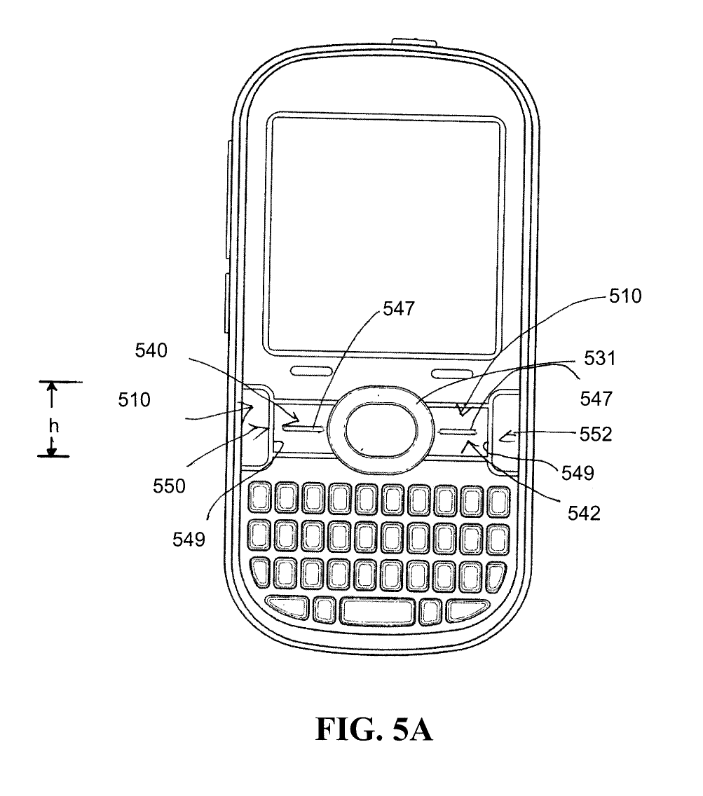

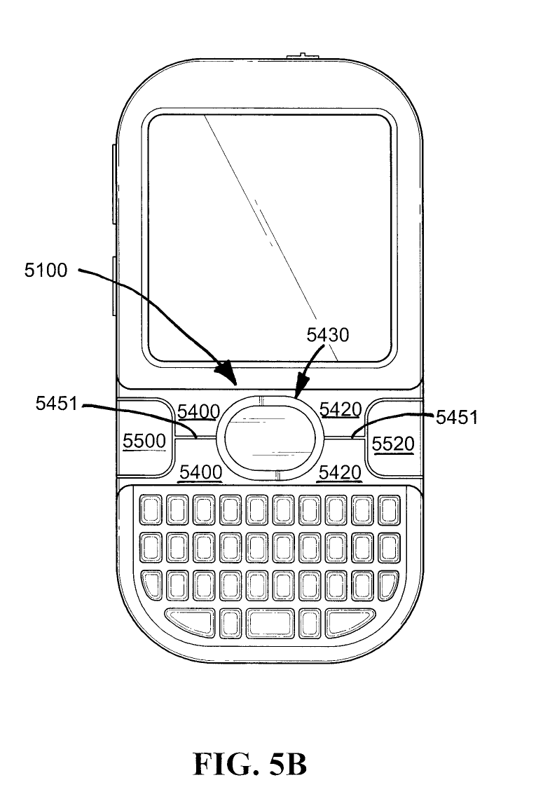

FIG. 4A-4C and FIG. 5A-FIG. 5B illustrate specific implementations of one or more embodiments, as provided on mobile computing devices for enabling cellular telephony and data transfer.

FIG. 4A illustrates an input area for use on a mobile computing device, according to an embodiment of the invention. With reference to an embodiment of FIG. 4A, an input area 410 of a device 400 includes a navigation mechanism 430, a first set of application buttons 440, a second set of application buttons 442, a first communication action button 450, and a second communication action button 452.

In an embodiment shown by FIG. 4A, navigation mechanism 430 includes an annular and elliptical ring 431 that circumvents an oval or elliptical center 433. The navigation mechanism 430 may be formed from a single surface component that is moveable in four or more regions (top, bottom, left, right) and at its center. Alternatively, the ring 431 and center 433 may be separately formed components. Other variations are also possible. The navigation mechanism 430 may overlay a pattern of switches (not shown in this figure) that enable signals to be generated from each of the five or more possible movements. In this way, the navigation mechanism 430 may be coupled to a processor to enable its operation for purpose of enabling navigation and selection input.

The application buttons sets 440, 442 may be shaped and contoured to provide a portion of the contact area for the input area 410. In one implementation, the application button sets 440, 442 are a single continuous surface that includes surface grooves or features which separate a top and a bottom half of a button set. For example, the contact surface provided for the application button sets 440, 442 may be formed from a plastic or molded component that has formed on it grooves indicating a separation of a top and bottom portion, as well as inked or colored portions indicating button functionality. The grooves may tactilely or visually distinguish top and bottom portions of the contact surface. The application button sets 440, 442 may be shaped to completely circumvent the call action buttons 450, 452, as well as the navigation button 430. In this way, a single continuous surface may provide four buttons that comprise the application button sets 440, 442. The number of buttons that may be provided by the contact surface of the application button sets 440, 442 may be determined by the number of electrical switches that underlie the facade. In one embodiment, the contact surface of the application button sets 442 overlays four switches. The contact surface of the application button sets 440, 442 may be moveable inward with focus or direction in quadrants that overlay individual electrical switches. Thus, under an embodiment such as shown by FIG. 4A, the contact surface of the application button sets 440, 442 may be used with, for example, dome electrical switches in order to simulate four different or independent buttons that comprise the application button sets 440, 442.

In an embodiment such as shown by FIG. 4A, the first and second communication action buttons 450, 452 are formed from partially symmetrical and polygonal shaped buttons. Each call action button 450, 452 may be provided within an opening that is defined by the shape or contour of the facade of the application button sets 450, 452. According to one implementation, each call action button 450, 452 has (i) rounded corners, (ii) a length dimension that is greatest on an interior end (adjacent to a rounded corner) and tapers from a bottom moving outward peripherally.

The input area 410 described with an embodiment of FIG. 4A may be similar to the input area of an embodiment such as described with FIG. 3, with the addition that the application button sets 440, 442 extend to circumvent both the navigation mechanism 430 and the call action buttons 450, 452. The navigation mechanisms 430 may comprise of a button set or feature that can be actuated in 5-states (4-directional and one selection state).

In terms of defining zones of the input area 410, the boundaries of the navigation mechanism 430 may define the navigation zone 462, as well as the height h of the input area 410. The application button sets 440, 442 may overlay switches (not shown) that reside and operate within application zones 465, 466 that are adjacent to the navigation zone 462. The operation of the application button sets 440, 442 may thus require inward movement of sections that overlay the switches, and the region where the inward movement is primarily focused may form the respective application zones 465, 466. At the same time, the surfaces of the application button sets 440, 442 may be shaped to extend and circumvent portions of both the navigation mechanism 430 and the respective call action buttons 450, 452. While the shaped surfaces of the application buttons 440, 442 may extend into other zones of the input area 410, the actuation portion of the application buttons 440, 442 that operate and move inward are in a zone that overlies the application button switch and which is positioned between the navigation input mechanism 430 and the respective call action button 450, 452.

As with other embodiments, the call action zones 467, 468 may be positioned adjacent to the application zones 465, 466. The call action zones 467, 468 may be defined by the boundaries of the call action buttons 450, 452. As mentioned, the shape of the contact surface that forms the application buttons 440, 442 may extend into the call action zones 467, 468, but the application buttons 440, 442 (i) reside primarily in the region overlaying the switch for the application buttons, and (ii) are operable from the region overlaying the switch, and not from the region surrounding the call action buttons 450, 452.

FIG. 4B illustrates a close-up of the call action zone of an embodiment such as shown and described with FIG. 4A. In an embodiment, the application button sets 440, 442 may comprise of an extended surface 445 that extends from the application zones 465, 466 to the adjacent call action zones 467, 468.The extended surface 445 may be moveable inward to actuate switches (e.g. contact domes) placed in the application zones 465, 466.

In an embodiment, the application button surfaces 445 circumvent the call action buttons 450, 452. Each call action button 450, 452 has a geometrical shape that is askew and/or rectangular. In the implementation shown, the call action button 450 includes two parallel lengths 490, 494, and two diverging widths 498, 499. The entire call action button 450 rests within an opening of the extended surface 445 of the application button 450. Multiple rounded corners 491, 493, 495, ad 497 may be provided, although deviations may include straight or non-rounded corners. A thickness 485 of the extended surface 445 of the application button 450 may non-uniformly (or uniformly) circumvent the call action button. The purpose of the thickness 485 may be decor, to provide the appearance of a continuous surface for the input area on which the mechanical features are provided.

FIG. 4C illustrates the extended surface 445 of the application button set 440, 442 extending around the navigation button set 430. The navigation button set 430 may include a combination of an annular ring 431 and a center select button 433. The annular ring may include an edge 437 or raised contour within that tactilely distinguishes the annular ring 433 from the adjoining extended surface 445.

Portions of the extended surface 445 that circumvent the navigation button set 430 include top thickness 481 and bottom thickness 483. The thicknesses 481, 483 may provide decor, and may be moveable or partially moveable when the entire surface is pressed inward. As mentioned, contact domes or other switches may be provided in the application button zones 465, 466. But while the extended surface may be partially moveable in zones other than the application zones, the primary and substantial presence of the application buttons is within the application button zones 465, 466.

In one embodiment, all of the application button sets 440, 442 share a single surface 445. In such an embodiment the extended surface 445 may be divided with markers or other visual cues to distinguish one button from another. In another embodiment, the extended surface 445 may be divided or separated amongst buttons and/or button sets.

FIG. 5A illustrates an input area for use on a mobile computing device, according to another embodiment of the invention. With reference to an embodiment of FIG. 5A, an input area 510 of a device 500 includes a navigation mechanism 530, a first set of application buttons 540, a second set of application buttons 542, a first communication action button 550, and a second communication action button 552.

The navigation mechanism 530 of FIG. 5A may be similar in construction to, for example, the navigation mechanism shown with FIG. 4A or other embodiments. The navigation mechanism 530 may include an annular and elliptical ring 531 that circumvents an oval or elliptical center 533. The navigation mechanism 530 overlays a pattern of switches that enable signals to be generated from each of the five or more possible movements. In this way, the navigation mechanism 530 may be coupled to a processor to enable its operation for purpose of enabling navigation and selection input.

In an embodiment, application buttons sets 540, 542 and call action buttons 550, 552 are collectively formed from single continuous surface that includes surface features that define buttons of the application button sets 540, 542 and the call action buttons 550, 552. In this way, horizontal markers or protrusions 547 may be used to visually separate regions of the application button sets 540, 542 to define separate buttons therein. Likewise, vertical markers or protrusions 549 may be used to visually separate the application button sets 540, 542 from the adjacent call action buttons 550, 552. In this respect, the buttons of the application button sets 540, 542 and the call action buttons 550, 552 may actually be button areas, rather than distinct and independent surface structures or keys. For example, under one implementation, the input area 510 may be formed from a sheet key having plastic film and surface features that define the various application button sets 540, 542 and call action buttons 550, 552. The sheet key may overlay a pattern of electrical switches that define points where inward movement of the sheet key results in generation of an actuation signal. Icons or other surface ornamentations may provide visual targets for where the user should press on the surface to effectuate a particular button.

Aside from the application button sets 540, 542 and the call action buttons 550, 552 being constructed from a continuous thickness, the input area 510 described with an embodiment of FIG. 5A may share some characteristics with the input area of an embodiment such as described with FIG. 4A. The application button sets 540, 542 partially circumvent the ring 531 of the navigation mechanism 530. Thus, each application button may be contoured on an edge that adjoins the navigation mechanism 530 to accommodate the arc of the ring 531. Protrusions may extend from the thickness of the continuous material that forms the button sets 540, 542 and the call action buttons 550, 552 in order to delineate or define individual buttons from one another.

As with other embodiments, the input area 510 may include a navigation zone 562, a first application zone 564, a second application zone 565, a first call action zone 567, and a second call action zone 568. The approximate boundaries of the zones of the input area 510 may be based on the positioning of the electrical switches, as well as surface ornamentations (e.g. icons) and surface protrusions and structures that identify button regions on the continuous thickness. The height h of the input area 510 may be set by the vertical dimension of the navigation mechanism 530.

As with other embodiments described herein, one or more embodiments may provide that some or all of the application buttons may alternatively be feature buttons. Thus, the application zone may correspond to a feature zone, or an application/feature zone (where both types of buttons are present).

FIG. 5B illustrates a variation to an input area design such as shown and described in FIG. 5A, under an embodiment of the invention. In FIG. 5B, the input area 5100 includes similarly shaped zones as described in an embodiment of FIG. 5A. Specifically, the input area 5100 includes application/feature button sets 5400, 5420, and call action button sets 5500, 5520. Rather than use a continuous surface that includes surface features to define buttons of the application button sets 5400, 5420 and the call action buttons 5500, 5520, an embodiment of FIG. 5B physically delineates the call action button sets 5500, 5520 from the application button sets 5400, 5420. But a continuous surface may be used to provide application/feature buttons of both sets (e.g. to the left and right side of the navigation button set 5430). For example, in the case where there are 3 or 4 application/feature buttons that comprise the sets 5400, 5420, one single surface may extend and provide each button of both application/feature zones. Within the button set of a particular application/feature zone, the continuous surface may be visually separated from to provide the appearance of different surfaces for different buttons. For example, a groove and/or marker 5451 may be included as a separation. Alternatively, the buttons of one or both application/button zones may be physically separated into two or more surfaces, for which some extend around the navigation button 5430 to form the surface of the application button of the other zone.

Furthermore, an embodiment of FIG. 5B illustrates how individual application buttons 5400, 5420 may partially circumvent the call action buttons 5500, 5520. For example, each call action button 5500, 5520 may include a strip at a top and bottom thickness within the input area 5100 from the extension of an adjacent application button 5400, 5420.

Additionally, as shown by an embodiment of FIG. 5B, each call action button 5500, 5520 may extend over an edge of the front panel and consume a portion of the thickness of the housing of the device. Thus, a dimension of the call action buttons 5500, 5520 may extend over an edge of the front face and occupy a thickness or edge-wise (e.g. between the front and back face) facade of the device.

Hardware Diagram

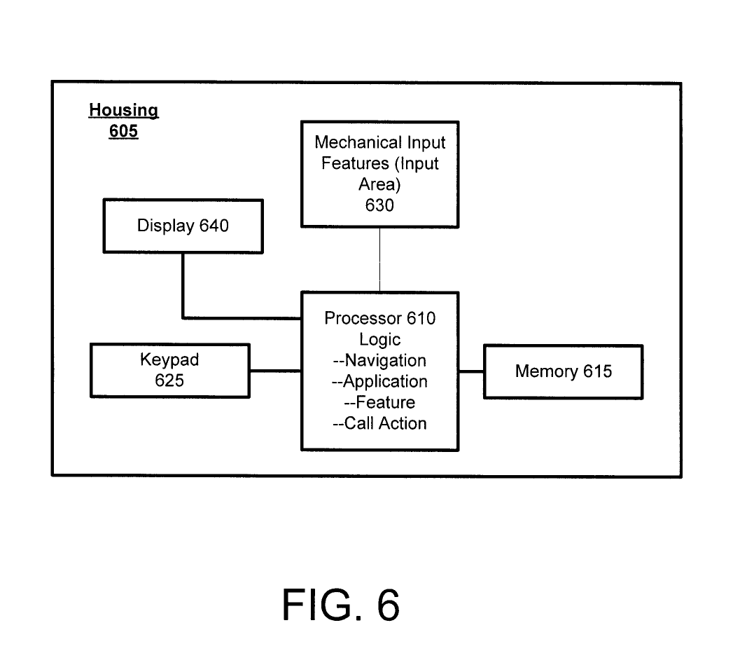

FIG. 6 is a simplified hardware diagram for use with one or more embodiments of the invention. A housing 605 for a mobile computing device (as shown with, for example, FIG. 1) may include various components, a processor 610 and memory resources 615. Numerous other components (now shown in an embodiment of FIG. 6), such as one or more wireless radio subsystems (e.g. for cellular, WiFi, WiMAX, or Bluetooth) may be included in the housing 605.

As shown with an embodiment of FIG. 6, processor 610 is coupled to a display component 640, a keypad 625, and mechanical interface features 630 of an input area such as described with any of the embodiments herein. According to one variation, the display component 640 may be contact sensitive. Alternatively, the display component 630 may be optical and light-sensitive (to simulate contact-sensitivity). The keypad 625 may be a keyboard, a number pad, or a combination thereof (e.g. keypad with dial pad provided). As a keyboard, a QWERTY layout may be provided.

The mechanical interface features 630 include navigation button sets, application button sets, and call action button sets. Processor 610 is configured to recognize input from actuation of any of the mechanical interface features 630, and to execute logic associated with the feature. As mentioned with one or more embodiments, the logic may be implemented in, for example, a default setting. When the navigation button set is operated, navigation logic 632 (directional or selection) is used to recognize the input with actuation of the individual navigation buttons or features. Likewise, application logic 634 or feature logic 636 may be associated and used with operation of one or more of the application (or feature) buttons. Call action logic 636 may be used when actuation of one or both of the call action buttons are recognized, under the appropriate setting.

Alternative Embodiments

As an alternative variation, one or more embodiments provide seamless and continuous contact areas that form the mechanical input features of a given button panel. According to one embodiment, the buttons of each call action zone and application/feature zone are continuous, smooth and flush with the housing of the device. Additionally, the display surface of the device may be flush with the housing, so that much of the input area, housing and display surface form a continuous flush surface.

While some embodiments described herein provide for call action buttons, one or more embodiments provide that the call action buttons (or mechanical input features) may be substituted to include alternative wireless communication activity, such as push to talk, messaging etc.

Still further, while numerous types of mechanical input features are listed for inclusion in a given input area of a device, other embodiments described herein may substitute the use of contact-sensitive surfaces, including resistive or capacitive surfaces. Still further, other embodiments provide for use of light sensitive surfaces. Still further, an input area described in accordance with any of the embodiments provided herein may be provided as part of a virtual display, such as on a contact-sensitive display, or alternatively on a illuminatable housing surface.

While embodiments described above provide for electrical switches that can be contacted by structures or by sections of film or other thicknesses, one or more embodiments provide that the mechanical input feature of the input area may be formed from contact-sensitive material. For example, portions of the input area may be formed from capacitive or resistive contact-sensitive material. In one embodiment, the display surface and the input area may be formed from resistive contact-sensitive material. In such embodiments, the user need to graze or make contact with the region of the input area that is assigned a particular functionality. The input area may be separated into regions that reflect the various buttons described with any of the aforementioned embodiments, including call action buttons, application and/or feature button sets and/or navigation buttons.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

What is claimed is:

1. A portable computing device comprising:
a housing having a front panel;
a multi-state button set operable to have multiple states of actuation;
a first perimeter button positioned adjacent or proximate to a first lateral edge of the front panel;
a first intermediate button set positioned laterally between the edge and the navigation button set;
a processor contained within the housing and configured to operate in a mode to (i) associate a set of multi-directional navigation functions with individual states of the multi-state button set, (ii) associate any one of two or more communication actions with the first perimeter button; and (iii) associate any one of a plurality of application or feature functions with each button of the first intermediate button set; and
wherein the first perimeter button and each button of the first intermediate button set are positioned on the front panel to at least extend onto a section of the front panel that is defined by (i) a first boundary that extends laterally from a top edge of the multi-state button set to the first lateral edge, and (ii) a second boundary that extends laterally from a bottom edge of the multi-state button set to the first lateral edge.

2. The portable computing device of claim 1, further comprising:
a second perimeter button positioned adjacent or proximate to a second lateral edge of the front panel;
a second intermediate button set positioned laterally between the second lateral edge and the navigation button set;
wherein the processor is configured, when operating in the mode, to: associate any one of the two or more communication actions with the second perimeter button, and associate any one of a plurality of application or feature functions with each button of the first intermediate button set.

3. The portable computing device of claim 2, wherein the first intermediate button set, the multi-state button set, and the first perimeter button are distributed symmetrically about at least a first horizontal reference that is orthogonal to at least a portion of the first lateral edge.

4. The portable computing device of claim 3, wherein the second intermediate button set, the multi-state button set, and the second perimeter button are distributed symmetrically about at least the first horizontal reference.

5. The portable computing device of claim 2, wherein at least one of the first intermediate button set, the second intermediate button set, and the multi-state button set include two or more buttons.

6. The portable computing device of claim 2, wherein the processor is configured, when operating in the mode, to associate a particular feature function with each button of the first intermediate set and each button of the second intermediate set.

7. The portable computing device of claim 6, wherein each of the particular feature functions corresponds to performance of a software control or selection operation of an application or hardware resource of the portable device.

8. The portable computing device of claim 2, wherein the processor is configured, when operating in the mode, to associate a particular one of the plurality of application buttons with one or more buttons of the intermediate button set, and wherein the processor is configured to open the particular application that is associated with a given button in the intermediate button set when the given button is pressed.

9. A portable computing device comprising:
a housing that provides a front panel, the front panel including a length and a width;
a processor provided with the housing;
a plurality of input mechanisms that are coupled to the processor and are operable to include a navigation mechanism, a set of application or feature mechanisms, and a set of communication action mechanism;
wherein the plurality of input mechanisms are distributed to at least partially extend onto an area that is defined by (i) a first boundary that extends from a first lateral edge to a second lateral edge of the front panel and is tangential to a top edge of the navigation mechanism, and (ii) a second boundary that extends from the first lateral edge to the second lateral edge of the front panel and is tangential to a bottom edge of the navigation mechanism;
wherein the set of communication action mechanisms include a first communication action mechanism that is provided adjacent or proximate to the first lateral edge, and a second communication mechanism that is provided adjacent or proximate to the second lateral edge;
wherein the set of application or feature mechanisms includes a first application or feature mechanism provided between a center of the area and the first communication action mechanism, and a second application or feature mechanism provided between the center of the area and the second communication action mechanism; and
wherein the navigation mechanism is provided between the first application or feature mechanism and the second application or feature mechanism and extends onto the center of the area.

10. The portable computing device of claim 9, wherein the plurality of input mechanisms are distributed symmetrically between the center and the first lateral edge.

11. The portable computing device of claim 10, wherein the plurality of input mechanisms are distributed symmetrically between the center and the second lateral edge.

12. The portable computing device of claim 9, wherein the navigation mechanism includes a multi-directional input mechanism and a centrally positioned center button.

13. The portable computing device of claim 9, wherein the set of application or feature mechanisms includes a third application or feature mechanism provided between the center of the area and the first communication action mechanism, and a fourth application or feature mechanism provided between the center of the area and the second communication action mechanism.

14. The portable computing device of claim 13, wherein the set of application or feature mechanisms include only buttons that launch or execute a corresponding application.

15. The portable computing device of claim 9, wherein the first communication action mechanism extends into the first lateral edge and the second communication action mechanism extends into the second lateral edge.

16. The portable computing device of claim 9, wherein the area on which the plurality of input mechanisms are distributed is structurally distinct from a remainder of the front panel of the housing.

17. The portable computing device of claim 16, further comprising a display assembly that includes a display area provided on the front panel above the area on which the plurality of input mechanisms are distributed, and wherein the portable computing device comprises a keypad that is provided below the area on which the plurality of input mechanisms are distributed.

18. The portable computing device of claim 9, wherein the first communication action mechanism and the second communication action mechanism are enlarged as compared to the set of application or feature mechanisms.

19. A portable computing device comprising:
a housing that provides a front panel, the front panel including a length and a width;
a display assembly that includes a display area provided with the front panel;
a plurality of actuation mechanisms, wherein each of the plurality of actuation mechanisms are provided at least in part on an input section of the front panel, the plurality of actuation mechanisms including a navigation mechanism, two or more telephonic action mechanisms, and a plurality of application/software feature mechanisms,
wherein the navigation mechanism is centrally disposed and has a vertical dimension that defines a height of the input section, the height extending in a direction corresponding to the length of the front panel;
wherein each of the two or more telephonic action mechanisms includes at least a portion that exclusively occupies a corresponding first and second perimeter region of the input section, the first perimeter region being positioned distal to the navigation mechanism and proximate or abutting to a first lateral edge, and the second perimeter region being positioned distal to the navigation mechanism and proximate or abutting to a second lateral edge of the front panel; and
wherein each of the first and second perimeter regions has a vertical dimension that corresponds to the height of the input section.
